(19) United States
(12) Patent Application Publication
(10) Pub. No.: US 2012/0110146 A1
(43) Pub. Date: May 3, 2012

(54) METHOD AND SYSTEM FOR REALIZING NETWORK TOPOLOGY DISCOVERY

(75) Inventors: Jing Tian, Guangdong Province (CN); Qihui Zhu, Guangdong Province (CN)

(73) Assignee: ZTE CORPORATION, Shenzhen City, Guangdong (CN)

(21) Appl. No.: 13/259,642

(22) PCT Filed: Sep. 11, 2009
(86) PCT No.: PCT/CN2009/073895

§ 371 Date: Jan. 10, 2012

(30) Foreign Application Priority Data
Jul. 28, 2009 (CN) 200910152093.9

(51) Int. Cl. G06F 15/177

(52) U.S. Cl. 709/220

(57) ABSTRACT

The present invention provides a method for realizing network topology discovery, which relates to a dynamic host configuration protocol (DHCP) client, a plurality of intermediate devices and a DHCP server and comprises: the intermediate devices recording successively address information of the intermediate devices into a DHCP option of a message in a DHCP message request sent by the DHCP client when receiving the message; and when receiving the message, the DHCP server storing a physical address of the DHCP client and information in the DHCP option carried in the message, while assigning an IP address to the DHCP client. The present invention is simple to implement, and can be implemented using only each sub-option in the original Option82 of the DHCP conveniently without additional devices, therefore it is suitable for network topology discovery of the LAN, and has high system performance-price ratio.

### TECHNICAL FIELD

The present invention relates to communication and network management field, and specifically to a method and system for realizing network topology discovery in the network management.

### BACKGROUND OF THE RELATED ART

With the arrival of information age, people's dependence on computer networks makes the reliability of running of the computer networks themselves very important. Therefore, a higher demand for network management is raised. A main object of network topology discover is to obtain and maintain existence information of network nodes and information of connection relationships between them, and, on the basis of this, to draw a topology diagram of the whole network. On the basis of the network topology diagram, network managers can locate fault nodes in the network fast.

Although there are many methods for discovering automatically network topology, they can come down to the following three types: a simple network management protocol (SNMP) based network topology discovery method, which is the network layer topology discovery; a general protocol based network topology discovery method, which is the link layer topology discovery; and a routing protocol based network topology discovery method, which is the routing layer topology discovery.

The principle of the network layer topology discovery is to inspect active devices in specified networks in combination with the interne control message protocol (ICMP) and the address resolution protocol (ARP) and the SNMP to obtain all the active devices, and obtain basic information of the devices by the SNMP, and determines types of the devices based on the basic information to obtain detailed information of corresponding devices based on the types of the devices.

The principle of the network layer topology discovery is to determine a connection relation between each switch based on a Cisco (the Cisco system company is a supplier of enterprise network products) discovery protocol (CDP) neighbor table, port index (ifIndex) and port corresponding table, self-learning table of the switch.

The principle of the router layer topology discovery is to trance route all of the device nodes, and obtain a routing topology relation between related devices based on a returned routing path.

At present, there are more and more applications where an IP address is assigned to each client in the LAN by a dynamic host configuration protocol (DHCP) server so as to provide network services for the client, the three methods mentioned above need to be equipped with a special system to implement network topology discovery, the scheme of which is relatively complicated and the pertinence is not strong, thereby resulting in extremely low performance-price ratio of the system.

### CONTENT OF THE INVENTION

A technical problem to be solved by the present invention is to provide a method for realizing network topology discovery so as to implement the network topology discovery specially for application scenarios where a DHCP server provides services for a client.

In order to solve the above technical problem, the present invention provides a method for realizing network topology discovery, which relates to a dynamic host configuration protocol (DHCP) client, a plurality of intermediate devices and a DHCP server and comprises:

the intermediate devices recording successively address information of the intermediate devices into a DHCP option of a message in a DHCP message request sent by the DHCP client when receiving the message; and

when receiving the message, the DHCP server storing a physical address of the DHCP client and information in the DHCP option carried in the message, while assigning an IP address to the DHCP client.

Further, the intermediate devices recording successively the address information of the intermediate devices into the DHCP option of the message when receiving the message comprises:

when the message passes by a first intermediate device, the first intermediate device adding the DHCP option into the message, and recording an IP address of the first intermediate device connected to the DHCP client into the fifth sub-option of the DHCP option, in addition to recording port information of the first intermediate device into the first sub-option of the DHCP option and recording a physical address of the first intermediate device into the second sub-option of the DHCP option; and

when the message passes by other intermediate devices, intermediate devices which receive the message recording IP address of the intermediate devices into the fifth sub-option of the DHCP option of the message successively.

Further, the method also comprises:

The DHCP server determining and storing position information of the DHCP client based on the physical address of the DHCP client and the information in the DHCP option, and determining and storing the plurality of intermediate devices between the DHCP client and the DHCP server and connection relations between the intermediate devices based on the information in the DHCP option.

Further, the method also comprises:

the DHCP server drawing a detailed network topology diagram based on the stored position information of the DHCP client and the intermediate devices and the connection relations between the intermediate devices.

Further, the method also comprises:

the DHCP server sending the position information of the DHCP client and the intermediate devices and the connection relations between the intermediate devices to a topology analysis system, which draws the detailed network topology diagram.

Further, the method also relates to a topology analysis system, and there is a plurality of involved DHCP servers; the method further comprises:

the DHCP servers sending the position information of the DHCP client and the intermediate devices and the connection relations between the intermediate devices to the topology analysis system, which draws the detailed network topology diagram based on the position information of the DHCP client and the intermediate devices and the connection relations between the intermediate devices.

Further, the method also relates a topology analysis system; the method further comprises:

the DHCP server sending the physical address of the DHCP client and the information in the DHCP option to the topology analysis system; and

the topology analysis system determining the position information of the DHCP client based on the physical address of the DHCP client and the information in the DHCP option, and determining and storing the plurality of intermediate devices between the DHCP client and the DHCP server and connection relations between the intermediate devices based on the information in the DHCP option; and drawing the detailed network topology diagram based on the stored position information of the DHCP client and the intermediate devices and the connection relations between the intermediate devices.

Further, there is a plurality of involved DHCP servers; the method further comprises:

the topology analysis system drawing the detailed network topology diagram based on the position information of the DHCP client and the intermediate devices and the connection relations between the intermediate devices, which are determined and stored based on the physical address of the DHCP client sent by the plurality of DHCP servers and the information in the DHCP option.

In order to solve the above problem, the present invention provides a system for realizing network topology discovery comprising a dynamic host configuration protocol (DHCP) client, a plurality of intermediate devices and a DHCP server connected successively, wherein:

the DHCP client is configured to initiate a DHCP message request when network services are required to be obtained;

the intermediate devices are configured to record successively address information of the intermediate devices into a DHCP option of a message in a DHCP message request sent by the DHCP client when receiving the message; and

the DHCP server is configured to, when receiving the message, store a physical address of the DHCP client and information in the DHCP option carried in the message, while assigning an IP address to the DHCP client.

Further, the plurality of the intermediate device comprises a first intermediate device and subsequent other intermediate devices.

The first intermediate device is configured to add the DHCP option into the received message, and record port information of the first intermediate device connected to the DHCP client into the first sub-option of the DHCP option, record a physical address of the first intermediate device into the second sub-option of the DHCP option, and record an IP address of the first intermediate device into the fifth sub-option of the DHCP option.

The other intermediate devices are configured to record IP addresses of the other intermediate devices into the fifth sub-option of the DHCP option of the message successively.

Further, the DHCP server is further configured to determine and store position information of the DHCP client based on the physical address of the DHCP client and the information in the DHCP option, and determine and store the plurality of intermediate devices between the DHCP client and the DHCP server and connection relations between the intermediate devices based on the information in the DHCP option.

Further, the DHCP server is further configured to draw a detailed network topology diagram based on the position information of the DHCP client and the intermediate devices and the connection relations between the intermediate devices.

Further, the system further comprises a topology analysis system, and there is a plurality of involved DHCP servers.

The DHCP server is further configured to send the position information of the DHCP client and the intermediate devices and the connection relations between the intermediate devices to the topology analysis system.

The topology analysis system is configured to draw the detailed network topology diagram based on the position information of the DHCP client and the intermediate devices and the connection relations between the intermediate devices, which are determined and stored based on the physical address of the DHCP client sent by the plurality of DHCP servers and the information in the DHCP option.

Using the method and the system for realizing network topology discovery provided by the present invention, in the process where a client sends a DHCP message request to a DHCP server, position information of the client and a mutual connection relation between each network node are obtained by Option82 information carried in the DHCP message and by topology analysis for the message and the Option82 information so as to draw a detailed network topology diagram, thereby achieving the goal of network topology discovery. The present invention is simple to implement, and can be implemented using only each sub-option in the original Option82 of the DHCP conveniently without additional devices, therefore it is suitable for network topology discovery of the LAN, and has high system performance-price ratio. The present invention provides a convenient, rapid and accurate fault location tool for network management.

### BRIEF DESCRIPTION OF DRAWINGS

FIG. 1 is a block diagram of an embodiment of a system for realizing network topology discovery in accordance with the present invention;

FIG. 2 is a flowchart of an embodiment of a method in accordance with the present invention;

FIG. 3 is a schematic diagram of change in Option82 information when a DHCP message passes by each intermediate device; and

FIG. 4 is a flowchart of a method for a topology analysis system to obtain network topology by Option82 information in accordance with an embodiment of the present invention.

### PREFERRED EMBODIMENTS OF THE PRESENT INVENTION

The inventive concept of the method and the system for realizing network topology discovery provided by the present invention is that when the client sends a DHCP message request to a DHCP server, it records address information of the client and each device which the message passes by, using a DHCP option carried in the message; when the HCP message finally arrives at a DHCP server, a detailed network topology diagram is drawn based on position information of the client and a mutual connection relation between each network node obtained by network topology analysis, thereby realizing the network topology discovery.

The technical scheme of the present invention is described in detail in conjunction with the accompanying drawings and preferred embodiments below. The following embodiments are only intended to describe and explain the present invention, and not constitute limitations of the technical scheme of the present invention.

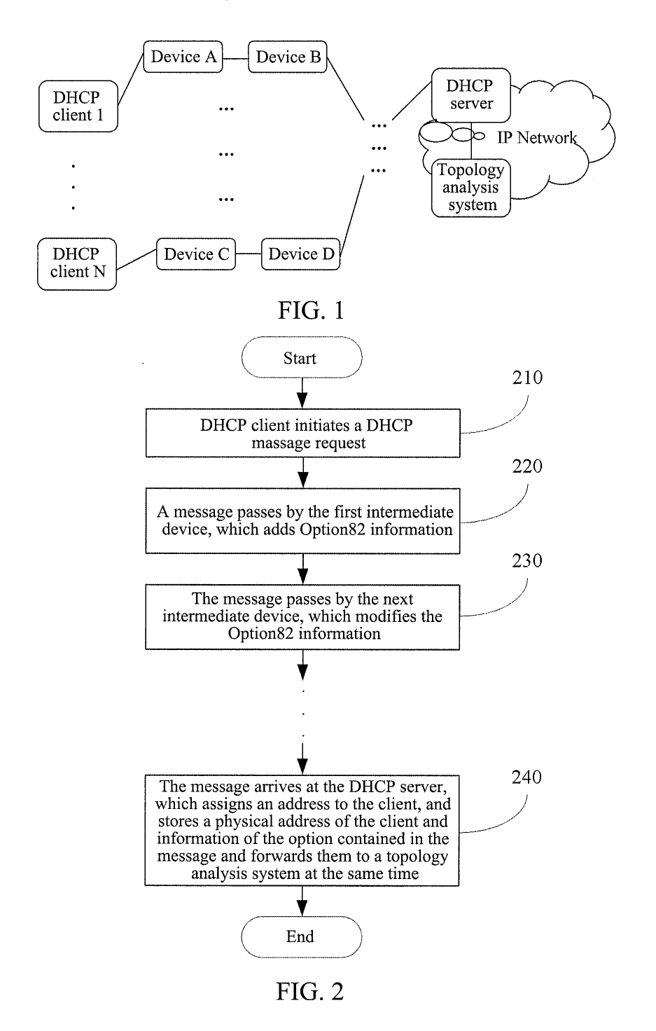

FIG. 1 illustrates a structure of an embodiment of a system for realizing network topology discovery in accordance with the present invention comprising a plurality of clients, a plurality of intermediate devices (device A, device B, . . . ) and one or more DHCP servers (only one of which is shown in FIG. 1) and a topology analysis system; one or more intermediate devices (such as switch, router, etc.) are connected between each client and DHCP server.

The client is configured to send a DHCP message request to the DHCP server when network services are required to be obtained.

The intermediate devices are configured to add and/or fill DHCP option (Option82) information into a DHCP message when receiving the message, and record their address information into the DHCP option successively.

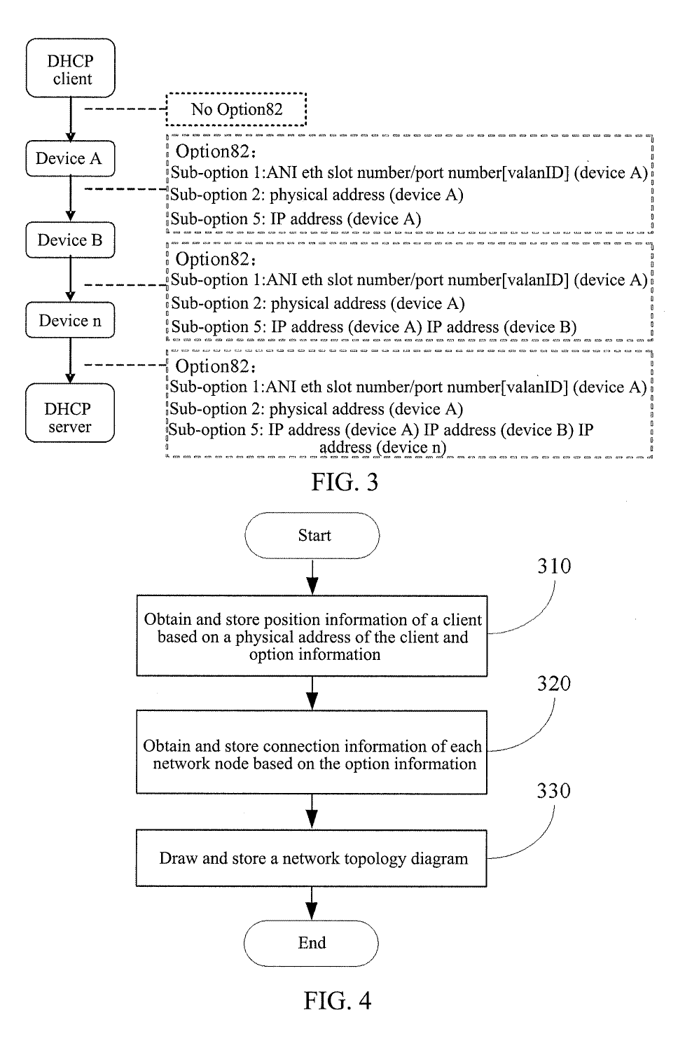

As shown in FIG. 3, when the DHCP message sent by the client passes by the first intermediate device (device A), the device adds Option82 information into the message by device A, the information includes the following sub-options.

Sub-option 1: proxy circuit ID, including a vlan ID, slot number and port number of a port of a switch connected to the client.

Sub-option 2: proxy remote ID, including the physical address of device A.

This physical address is used for determining uniquely the position of device A.

Sub-option 5: link selection, including the IP address of device A.

The DHCP message passes by the second intermediate device (device B), . . . the n-th intermediate device (device n) successively, and device B, . . . , device n fill their IP addresses respectively into the sub-option 5.

The DHCP server is configured to, when receiving the DHCP message, assign an address to the client that sends the message request, while storing the physical address of the client and option information carried in the message, and send them to a topology analysis system connected to the DHCP server;

The topology analysis system is configured to determine position information of the client based on the physical address of the client and the option information, determine the intermediate devices between the client and the DHCP server and connection relations between the intermediate devices based on the option information, and store the position information of the client and the intermediate devices and their connection relations into a data base; and finally draw a detailed network topology diagram based on the position information of the client and the intermediate devices and their connection relations recorded in the data base.

The topology analysis system determines the position information of the client based on the physical address of the client and IP addresses of the first intermediate devices of the sub-option 5, sub-option 1, sub-option 2 in the option information to record into the data base; determines intermediate devices that the DHCP message passes by and connection relations between the intermediate devices based on IP addresses of all devices included in sub-option 5 to record in the data base; enriches constantly the position information of the client in the data base and many devices associated with the client and their connection relations by accumulating information of the client in the message so as to draw a detailed network topology diagram.

In addition to the above-mentioned embodiment of the system, other embodiments may also be presented in the present invention.

For example, the function for the above-mentioned topology analysis system to analyze the physical address of the client and the option information may be achieved by configuring a topology analysis module in the DHCP server, that is to say, this topology analysis module determines the position information of the client based on physical address of the client and the option information stored in the DHCP server and corresponding to the DHCP message, and determines the intermediate devices between the client and the DHCP server and connection relations between the intermediate devices based on this option information, and draws a network topology diagram.

As another example, the above-mentioned topology analysis system may aggregate all network topology diagrams drawn in the DHCP servers connected to the topology analysis system, and analyses these diagrams and finally draws a larger and more complete network topology diagram.

FIG. 2 illustrates a flowchart of an embodiment of a corresponding method given by the above-mentioned embodiment of the system in accordance with the present invention comprises the following steps.

210. A DHCP client initiates a DHCP message request.

The client initiates the DHCP message request to a DHCP server when network services are required to be obtained.

220. A message passes by the first intermediate device, which adds and fills DHCP option (Option82) information.

As shown in FIG. 3, the message passes first by device A, for example, which adds Option82 information into the message, i.e., sub-option information: proxy circuit ID of sub-option 1, including a vlanID, slot number and port number of a port of a switch connected to the client; proxy remote ID of sub-option 2, including the physical address of device A; the link selection of sub-option, including the IP address of device A.

230. The message passes by the next intermediate device, which modifies Option82 information.

The message is transmitted to the next device B by device A, device B fills its IP address into the sub-option 5 in the Option82.

Next, the DHCP message passes by the third intermediate device, . . . the n-th intermediate device (device n) successively, these devices fill their IP addresses into the sub-option 5 respectively.

240. The message arrives at the DHCP server, which assigns an address to the client, and stores the physical address of the client and the option information carried in the message, and forwards them to a topology analysis system at the same time, and then the process ends.

FIG. 4 illustrates a flowchart of a method for a topology analysis system to obtain network topology by Option82 information in accordance with an embodiment of the present invention comprising the following steps.

310. Position information of a client is obtained based on the physical address of the client and option information and is stored.

Based on the physical address of the client and IP addresses of the first intermediate devices of sub-option 5, sub-option 1, sub-option 2 in the option information, the position information of the client is determined and is stored.

320. Connection information of each network node is obtained based on the option information and is stored.

Intermediate devices that the message passes by and connection relations between these intermediate devices are determined based on IP addresses of all devices included in the sub-option 5, and are stored.

330. A network topology diagram is drawn and stored, and then the process ends.

Of course, the processes in the FIG. 2 and the FIG. 4 are performed separately in the embodiment, the DHCP server obtains the message and the Option82 information therein, and the topology analysis system obtains network topology by the Option82 information. In fact, the processes in the FIG. 2 and FIG. 4 may be performed in combination, the DHCP server obtains the message and the Option82 information therein, and obtains the position information of the client and the intermediate devices associated with the client and their connection relations based on the address information of the client and the Option82 information so as to draw the network topology diagram.

In the method and the system for realizing network topology discovery provided by the present invention, in the process where a client sends a DHCP message request to a DHCP server, position information of the client and a mutual connection relation between each network node are obtained by Option82 information carried in the DHCP message and by topology analysis for the message and the Option82 information so as to draw a detailed network topology diagram, thereby achieving the goal of network topology discovery. The present invention is simple to implement, and can be implemented using only each sub-option in the original Option82 of the DHCP conveniently without additional devices, therefore it is suitable for network topology discovery of the LAN, and has high system performance-price ratio. The present invention provides a convenient, rapid and accurate fault location tool for network management.

It should be understood that equivalent variations or substitutions may be made by those having ordinary skill in the art according to the technical concept of the present invention, and all the variation or substitution schemes without additional creative work should fall within the protection scope of the appended claims of the present invention.

### INDUSTRIAL APPLICABILITY

Using the method and the system for realizing network topology discovery provided by the present invention, in the process where a client sends a DHCP message request to a DHCP server, position information of the client and a mutual connection relation between each network node are obtained by Option82 information carried in the DHCP message and by topology analysis for the message and the Option82 information so as to draw a detailed network topology diagram, thereby achieving the goal of network topology discovery. The present invention is simple to implement, and can be implemented using only each sub-option in the original Option82 of the DHCP conveniently without additional devices, therefore it is suitable for network topology discovery of the LAN, and has high system performance-price ratio. The present invention provides a convenient, rapid and accurate fault location tool for network management.

1. A method for realizing network topology discovery comprising: a dynamic host configuration protocol (DHCP) client sending a DHCP message request to a DHCP server, a message in the DHCP message request passing by a plurality of intermediate devices; the intermediate devices recording successively address information of the intermediate devices into a DHCP option of the message when receiving the message; and
when receiving the message, the DHCP server assigning an IP address to the DHCP client and storing a physical address of the DHCP client and information in the DHCP option carried in the message.

2. The method according to claim 1, wherein the intermediate devices recording successively the address information of the intermediate devices into the DHCP option of the message when receiving the message comprises:
when a first intermediate device which firstly receives the message among the intermediate devices receives the message, the first intermediate device adding the DHCP option into the message, and recording an IP address of the first intermediate device connected to the DHCP client into the fifth sub-option of the DHCP option, in addition to recording port information of the first intermediate device into the first sub-option of the DHCP option and recording a physical address of the first intermediate device into the second sub-option of the DHCP option; and
when other intermediate devices except the first intermediate device receive the message, the other intermediate devices recording IP address of the other intermediate devices into the fifth sub-option of the DHCP option of the message successively.

3. The method according to claim 1, further comprising:
the DHCP server determining and storing position information of the DHCP client based on the physical address of the DHCP client and the information in the DHCP option, and determining and storing the plurality of intermediate devices between the DHCP client and the DHCP server and connection relations between the intermediate devices based on the information in the DHCP option.

4. The method according to claim 3, wherein after the step of the DHCP server determining and storing position information of the DHCP client and determining and storing the intermediate devices and connection relations between the intermediate devices, the method further comprises:
the DHCP server drawing a detailed network topology diagram based on the stored position information of the DHCP client and the intermediate devices and the connection relations between the intermediate devices.

5. The method according to claim 4, wherein the step of the DHCP server drawing the detailed network topology diagram based on the stored position information of the DHCP client and the intermediate devices and the connection relations between the intermediate devices comprises:
the DHCP server sending the position information of the DHCP client and the intermediate devices and the connection relations between the intermediate devices to a topology analysis system, which draws the detailed network topology diagram.

6. The method according to claim 4, wherein
there is a plurality of DHCP servers;
the step of the DHCP server drawing the detailed network topology diagram based on the stored position information of the DHCP client and the intermediate devices and the connection relations between the intermediate devices comprises:
each of the plurality of DHCP servers sending the position information of the DHCP client stored by each of the plurality of DHCP servers and the intermediate devices and the connection relations between the intermediate devices to the topology analysis system, which draws the detailed network topology diagram.

7. The method according to claim 1, further comprising:
the DHCP server sending the physical address of the DHCP client and the information in the DHCP option to the topology analysis system; and
the topology analysis system determining the position information of the DHCP client based on the physical address of the DHCP client and the information in the DHCP option, and determining and storing the plurality of intermediate devices between the DHCP client and the DHCP server and connection relations between the intermediate devices based on the information in the DHCP option; and drawing the detailed network topology diagram based on the stored position information of the DHCP client and the intermediate devices and the connection relations between the intermediate devices.

8. The method according to claim 7, wherein there is a plurality of DHCP servers;
the step of the topology analysis system drawing the detailed network topology diagram based on the stored position information of the DHCP client and the intermediate devices and the connection relations between the intermediate devices comprises: the topology analysis system drawing the detailed network topology diagram based on the position information of the DHCP client and the intermediate devices and the connection relations between the intermediate devices, which are determined and stored based on the physical address of the DHCP client stored by each of the plurality of DHCP servers and the information in the DHCP option.

9. A system for realizing network topology discovery comprising a dynamic host configuration protocol (DHCP) client, a plurality of intermediate devices and a DHCP server connected successively, wherein:
the DHCP client is configured to initiate a DHCP message request when network services are required to be obtained;
the intermediate devices are configured to record successively address information of each of the intermediate devices into a DHCP option of a message in a DHCP message request sent by the DHCP client when receiving the message; and
the DHCP server is configured to, when receiving the message, store a physical address of the DHCP client and information in the DHCP option carried in the message, while assigning an IP address to the DHCP client.

10. The system according to claim 9, wherein the plurality of the intermediate device comprises a first intermediate device and subsequent other intermediate devices;
the first intermediate device is configured to add the DHCP option into the received message, and record port information of the first intermediate device connected to the DHCP client into the first sub-option of the DHCP option, record a physical address of the first intermediate device into the second sub-option of the DHCP option, and record an IP address of the first intermediate device into the fifth sub-option of the DHCP option; and
the other intermediate devices are configured to record IP addresses of the other intermediate devices into the fifth sub-option of the DHCP option of the received message successively.

11. The system according to claim 9, wherein
the DHCP server is further configured to determine and store position information of the DHCP client based on the physical address of the DHCP client and the information in the DHCP option, and determine and store the intermediate devices between the DHCP client and
the DHCP server and connection relations between the intermediate devices based on the information in the DHCP option.

12. The system according to claim 11, wherein
the DHCP server is further configured to draw a detailed network topology diagram based on the position information of the DHCP client and the intermediate devices and the connection relations between the intermediate devices.

13. The system according to claim 11, wherein the system further comprises a topology analysis system, and there is a plurality of involved DHCP servers;
the DHCP server is further configured to send the position information of the DHCP client and the intermediate devices and the connection relations between the intermediate devices to the topology analysis system; and
the topology analysis system is configured to draw the detailed network topology diagram based on the position information of the DHCP client and the intermediate devices and the connection relations between the intermediate devices, which are determined and stored based on the physical address of the DHCP client sent by each of the plurality of DHCP servers and the information in the DHCP option.

14. The method according to claim 2, further comprising:
the DHCP server determining and storing position information of the DHCP client based on the physical address of the DHCP client and the information in the DHCP option, and determining and storing the plurality of intermediate devices between the DHCP client and the DHCP server and connection relations between the intermediate devices based on the information in the DHCP option.

15. The method according to claim 2, further comprising:
the DHCP server sending the physical address of the DHCP client and the information in the DHCP option to the topology analysis system; and
the topology analysis system determining the position information of the DHCP client based on the physical address of the DHCP client and the information in the DHCP option, and determining and storing the plurality of intermediate devices between the DHCP client and the DHCP server and connection relations between the intermediate devices based on the information in the DHCP option; and drawing the detailed network topology diagram based on the stored position information of the DHCP client and the intermediate devices and the connection relations between the intermediate devices.

16. The system according to claim 10, wherein
the DHCP server is further configured to determine and store position information of the DHCP client based on the physical address of the DHCP client and the information in the DHCP option, and determine and store the intermediate devices between the DHCP client and the DHCP server and connection relations between the intermediate devices based on the information in the DHCP option.
